(19) United States
(12) Patent Application Publication
(10) Pub. No.: US 2010/0145885 A1
(43) Pub. Date: Jun. 10, 2010

(54) SYSTEM FOR ON-BOARD METERING OF RECHARGING ENERGY CONSUMPTION IN VEHICLES EQUIPPED WITH ELECTRICALLY POWERED PROPULSION SYSTEMS

(75) Inventors: James M. Graziano, Hotchkiss, CO (US); George Kauss, San Antonio, TX (US); Daniel B. McKenna, Vail, CO (US); Richard M. Tyler, Evergreen, CO (US)

Correspondence Address: PATTON BOGGS LLP, 1801 CALFORNIA STREET, SUITE 4900, DENVER, CO, 80202, US

(73) Assignee: Lava Four, LLC, Vail, CO (US)

(21) Appl. No.: 12/329,368

(22) Filed: Dec. 5, 2008

(51) Int. Cl. G06F 17/00; H02J 7/04

(52) U.S. Cl. 705/412; 320/165

(57) ABSTRACT

The System For On-Board Metering Of Recharging Power Consumption In Vehicles Equipped With Electrically Powered Propulsion Systems uses a unique identification of the associated Self-Identifying Outlet and the power consumption as metered on the Self-Reporting Vehicle to enable the Self-Reporting Vehicle to report the Self-Reporting Vehicle's power consumption to the utility company to enable the utility company to bill the vehicle owner and credit the account of the Self-Identifying Outlet for the power consumed by the recharging of the vehicular battery banks.

### CROSS-REFERENCE TO RELATED APPLICATIONS

This Application is related to a US Application titled “Self-Identifying Power Source For Use In Recharging Vehicles Equipped With Electrically Powered Propulsion Systems”, and a US Application titled “Network for Authentication, Authorization, and Accounting Of Recharging Processes For Vehicles Equipped With Electrically Powered Propulsion Systems”, both filed on the same date as the present application and incorporating the disclosures of each herein.

### FIELD OF THE INVENTION

This invention relates to a system for use in recharging vehicles which are equipped with electrically powered propulsion systems, where each outlet provides a unique outlet identification to the vehicle for power consumption billing purposes, where the metering and reporting of power consumption is done by the vehicle.

### BACKGROUND OF THE INVENTION

It is a problem in the field of recharging systems for vehicles equipped with electrically powered propulsion systems to bill the vehicle operator for the energy consumption where the electric grid is used as the source of power to charge the vehicular battery banks. Presently, each outlet that is served by a local utility company is connected to the electric grid by an electric meter which measures the energy consumption of the loads that are connected to the outlet. The utility company bills the owner of the premises at which the outlet is installed for the total energy consumption for a predetermined time interval, typically monthly. Recharging a vehicle which is equipped with an electrically powered propulsion system results in the premises owner errantly being billed for the recharging and the vehicle owner not being billed at all. An exception to this scenario is where the premises owner is paid a flat fee by the vehicle owner for the use of the outlet to recharge the vehicular battery banks.

Electric transportation modes typically take the form of either a pure battery solution where the battery powers an electric propulsion system, or a hybrid solution where a fossil fuel powered engine supplements the vehicle's battery bank to either charge the electric propulsion system or directly drive the vehicle. Presently, there is no electricity refueling paradigm, where a vehicle can plug in to the “electric grid” while parked at a given destination and then recharge with sufficient energy stored in the vehicular battery banks to make the trip home or to the next destination. More to the point, the present “grid paradigm” is always “grid-centric”; that is, the measurement and billing for the sourced electricity is always done on the grid's supply side by the utility itself. One example of a system that represents this philosophy is the municipal parking meter apparatus where an electric meter and credit card reader is installed at every parking meter along a city's streets to directly bill vehicle owners for recharging their vehicular battery banks. Not only is this system very expensive to implement, but it remains highly centralized and is certainly not ubiquitous. This example solution and other analogous grid-centric solutions are not possible without an incredible capital expenditure for new infrastructure and an extensive build time to provide widespread recharging capability.

Thus, the problems with centralized vehicular charging are:
infrastructure cost,
lack of ubiquity in the infrastructure's extent,
extensive time to deploy a nationwide system,
can't manage/control access to electricity without a per outlet meter,
no ubiquity of billing for downloaded electricity,
no method to assure a given utility is properly paid,
no method to provide revenue sharing business models,
no methods to manage and prevent fraud,
incapable of instantaneous load management during peak loads,
incapable of load management on a block by block, sector by sector load, or city-wide basis, and
incapable of billing the energy “downloaded” to a given vehicle, where a given vehicle is random in its extent, and where the vehicle is plugged into the grid is also random in its extent.

What is needed is a solution that can be deployed today, that doesn't require a whole new infrastructure to be constructed, is ubiquitous in its extent, and that uses modern communications solutions to manage and oversee the next generation electric vehicle charging grid.

### BRIEF SUMMARY OF THE INVENTION

The above-described problems are solved and a technical advance achieved by the present System For On-Board Metering Of Recharging Power Consumption In Vehicles Equipped With Electrically Powered Propulsion Systems (termed “Self-Reporting Vehicle” herein) which uses a unique identification of the associated Self-Identifying Outlet and the power consumption as metered on the Self-Reporting Vehicle to enable the Self-Reporting Vehicle to report the Self-Reporting Vehicle's power consumption to the utility company to enable the utility company to bill the vehicle owner and credit the account of the Self-Identifying Outlet for the power consumed by the recharging of the vehicular battery banks.

A key element of the conceptual “Charging-Grid” solution presented herein is not unlike the problem faced by early cellular telephone operators and subscribers. When a cellular subscriber “roamed” out of their home “network”, they couldn't make phone calls, or making phone calls was either extremely cumbersome or expensive or both. The present Self-Reporting Vehicle is a part of an “E-Grid” billing structure, which includes full AAA functionality—Authentication, Authorization, and Accounting. For the early historical cellular paradigm, the cellular architecture used a centralized billing organization that managed the “roaming” cellular customer. In a like fashion, the E-Grid proposed herein has a centralized billing structure that manages the “roaming” vehicle as it “self-charges” at virtually any power source/electric outlet in a seamless yet ubiquitous manner anywhere a given utility is connected to the “E-Grid architecture”.

A second component of the E-Grid is to place the “electric meter” in the vehicle itself to eliminate the need to modify the electric grid. The present Self-Reporting Vehicle provides the vehicle's electric meter with a unique identification of the power source to enable the vehicle to report both the vehicle's energy consumption and the point at which the energy consumption occurred to the utility company via the ubiquitous communications network.

An advantage of this architecture is that the vehicle is in communication with the utility company, which can implement highly dynamic load management, where any number of vehicles can be “disconnected” and “re-connected” to the electric grid to easily manage peak load problems for geographic areas as small as a city block or as large as an entire city or even a regional area.

The innovative “E-Grid” architecture enables a vehicle to plug in anywhere, “self-charge”, and be billed in a seamless fashion, regardless of the utility, regardless of the vehicle, regardless of the location, regardless of the time. The utility for that given downloaded charge receives credit for the electricity “downloaded” across their network, whether that customer is a “home” customer or a “roaming” customer. The “owner” of the electrical outlet receives credit for the power consumed from their “electrical outlet”. In addition, if a given customer has not paid their E-Grid bill, the system can directly manage access to the grid to include rejecting the ability to charge or only allowing a certain charge level to enable someone to get home. The E-Grid architecture can have account managed billing, pre-paid, and post-paid billing paradigms. The billing is across any number of electric utility grids, and the E-Grid architecture is completely agnostic to how many utility suppliers there are or where they are located. So too, the E-grid architecture is agnostic to the charging location, where said charging location does not require a meter and does not require telecommunications capability.

The compelling societal benefit of the novel E-Grid architecture is that it is possible to deploy it today, without a major change in current infrastructure or requiring adding new infrastructure. Virtually every electrical outlet, no matter where located, can be used to charge a vehicle, with the bill for that charge going directly to the given consumer, with the owner of the electrical outlet getting a corresponding credit, and with the payment for electricity going directly to the utility that provided the energy—all in a seamless fashion.

### BRIEF DESCRIPTION OF THE DRAWINGS

FIG. 1 illustrates, in block diagram form, the E-Grid network architecture, including interconnected communication networks with a unified authentication, authorization, and accounting structure;

FIG. 2 illustrates, in block diagram form, a more detailed embodiment of the E-Grid network architecture shown in FIG. 1 which discloses multiple utility companies;

FIG. 3 illustrates, in flow diagram form, the operation of the billing system for the E-Grid system;

FIG. 4 illustrates, in block diagram form, the Charging, Control, and Communicator (CCC) module installed in a vehicle;

FIG. 5 illustrates, in block diagram form, a detailed block diagram of the CCC module;

FIG. 6 illustrates an embodiment of the present Self-Identifying Outlet for use in the E-Grid system; and

FIG. 7 illustrates, in block diagram form, the communications interconnections in use in the E-Grid network.

### DETAILED DESCRIPTION OF THE INVENTION

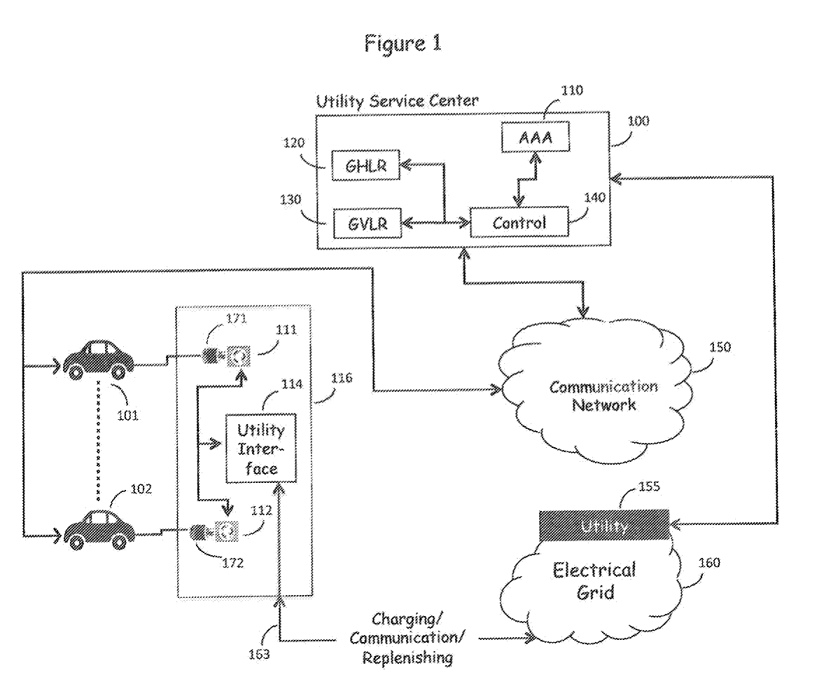

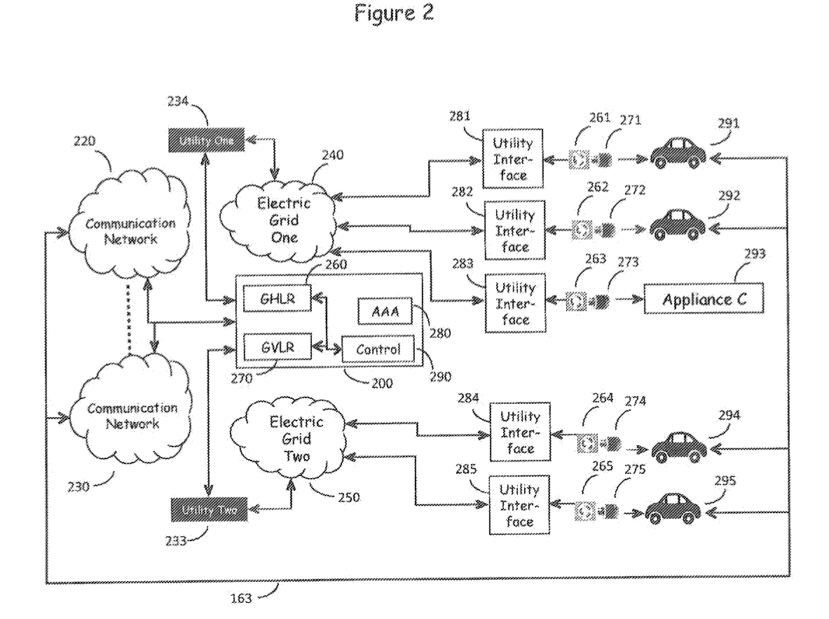

FIG. 1 illustrates, in block diagram form, the E-Grid network architecture, including interconnected communications networks with a unified authentication, authorization, and accounting structure, while FIG. 2 illustrates, in block diagram form, a more detailed embodiment of the E-Grid network architecture shown in FIG. 1. In the following description, the term “Vehicle” is used, and this term represents any mechanism which includes a propulsion system powered, at least in part, by electric power, at least some of which is stored onboard the vehicle in an electric power storage apparatus, as well as any electric power consuming loads incorporated into, transported by, or associated with any type of vehicle, whether or not these types of vehicles are electrically powered.

### Traditional Electric Grid

Electric Grid 160 shown in FIG. 1 represents the source of electric power, as provided by multiple utility companies which serve a wide geographic area. For the purpose of illustration, the present description focuses on a single utility company 155 which serves a particular geographic area (service area) and provides electric power to a multitude of customers, via a utility interface 114 which typically comprises an electric meter which is installed at the customer's facilities 116 and an associated service disconnect. The Utility Interface 114 also can have advanced concepts such as a virtual meter that is interconnected via an advanced telecom network using Power Line Carrier (PLC) across the grid. Nothing herein limits the physical elements contained with device 114 to include that a meter may not be a part of 114 in certain applications.

The electric meter in this example shown in utility interface 114 serves to measure the energy consumption by the various outlet connected loads, such as Vehicles 101, 102 and fixed loads (not shown) which are connected to the customer's electric meter via a customer's service disconnect (circuit breaker panel), which is part of the utility interface 114 for the purpose of this description. These elements represent the existing electric power delivery infrastructure. The arrow shown at the bottom of FIG. 1 highlights the fact that the connection to Electric Grid 160 is bidirectional in that electric power traditionally flows from the electric grid 160 to the utility interface 114 and thence to the customer's loads—Vehicles 101, 102—but also can flow in the reverse direction, from the vehicular battery banks of Vehicles 101, 102, through the utility interface 114 to the electric grid 160, and these conductors can also carry Power Line Carrier (PLC) communications which consist of data to provide communications for such purposes as electrical outlet identification 111 via 171 to 101 for example. The PLC communication network could also be used as an alternate communication pathway to the Utility Service Center 100 for AAA functionality.

### Utility Service Center

Communication Network 150 is the preferred communication medium which enables the Vehicles 101, 102 to communicate with Utility Service Center 100 to implement the Vehicle registration and billing processes under control of Control 140 via Grid Home Location Register (GHLR) 120 and Grid Visitor Location Register (GVLR) 130. The communication network 150 comprises any technology: cellular, WiFi, wired Public Switched Telephone Network (PSTN), Internet, etc. The Grid Home Location Register 120 and Grid Visitor Location Register 130 are further connected to the Authentication, Authorization, and Accounting System 110 (AAA System 110). The communication mode for the Vehicles 101, 102 can be wireless, wired (such as via network 150), or via the Electric Grid 160 using Power Line Carrier as previously mentioned. For the purpose of illustration, a wireless link to the Communication Network 150 is used in this embodiment, although the other modes can be used.

The Vehicles 101, 102 first communicate with Communication Network 150 in well-known fashion to link to Utility Service Center 100 where the control processor 140 accesses the Location Registers 120 and 130. These devices contain the entire user profile for the account holder: home utility company, billing account, maximum authorized credit, where authorized to charge, identification of any value added services that they subscribe to, and so on. When registering with the Utility Service Center 100, the Vehicles 101, 102 first seek to register with the Grid Home Location Register 120 if in their home territory (i.e., within the territory served by their residence's electric utility provider). If Vehicle 101 is traveling outside of its home territory, it would first register with the serving utility's Grid Visitor Location Register 130 which would then communicate with the home Grid Home Location Register 120 to confirm it is a “real” customer, and all of the data stored in the Grid Home Location Register 120 about a particular customer is copied to the Grid Visitor Location Register 130 while the Vehicle 101 is in the “roaming” territory. Communications via network 150 (typically via wireless means) would let the Vehicles 101, 102 know whether they are in the home territory or whether they are roaming (not unlike how cellular phone networks operate today). After successful registration, the AAA System 110 begins to manage the charging transaction.

At AAA System 110, a number of essential functions occur. All Vehicles seeking to receive electrical power from Electric Grid 160 to charge the vehicular battery banks (also termed “electric energy storage apparatus”) are first authenticated, then authorized, and billed for the energy consumed via the charging process. Authentication means that a device is valid and permitted to access the Electric Grid 160 (the authorization phase of AAA). AAA System 110 also manages the accounting process, ensuring that all bills go to the correct vehicle owner, the electric utility gets paid for the electricity that it supplied, and the owner of utility interface 114 is credited with the electricity that flowed through utility interface 114 to recharge the vehicular battery banks. There could also be revenue share models where a facility owner could get a portion of the overall charging bill for providing physical access (i.e., an electrical plug-in location). AAA System 110 is seen as a more central device, to be shared among a number of electric utilities, although there is nothing from preventing each utility from having its own AAA System.

### Multi-Utility Embodiment

FIG. 1 is in reality a multidimensional network in which N electric utilities are served by M Electric Grids with corresponding communication networks, as shown in FIG. 2.

Electric Grids 240, 250 shown in FIG. 2 represent the source of electric power as provided by multiple utility companies which serve a wide geographic area and provide electric power to a multitude of customers via utility interfaces 281-285. The utility interfaces 281-285 serve to measure the energy consumption by the various outlet connected loads, such as Vehicles 291-295. These elements represent the existing, present day electric power delivery infrastructure as described above. Electric power traditionally flows from the electric grid 240, 250 to the utility interfaces 281-285 and thence to the customer's loads—Vehicles 291-295 via plug 261-265-outlet 271-275 combinations—but power also can flow in the reverse direction, from the vehicular battery banks of Vehicles 291-295, through the utility interfaces 281-285 to the electric grids 240, 250.

Communication Networks 220, 230 are the communication mediums which enable the Vehicles 291-295 to communicate with Utility Service Center 200 which, as noted above, implements the Vehicle registration process via Grid Home Location Register (GHLR) 260 and Grid Visitor Location Register (GVLR) 270. The Grid Home Location Register 260 and Grid Visitor Location Register 270 are further connected to the Authentication, Authorization, and Accounting System 280 (AAA System 280). The communication mode for the Vehicles 291-295 can be wireless, wired, or via the electric grid, as previously discussed. For the purpose of illustration, a wireless link to the Communication Networks 220, 230 is used in this embodiment, although the other communication modes can be used.

### Self-Identifying Outlet

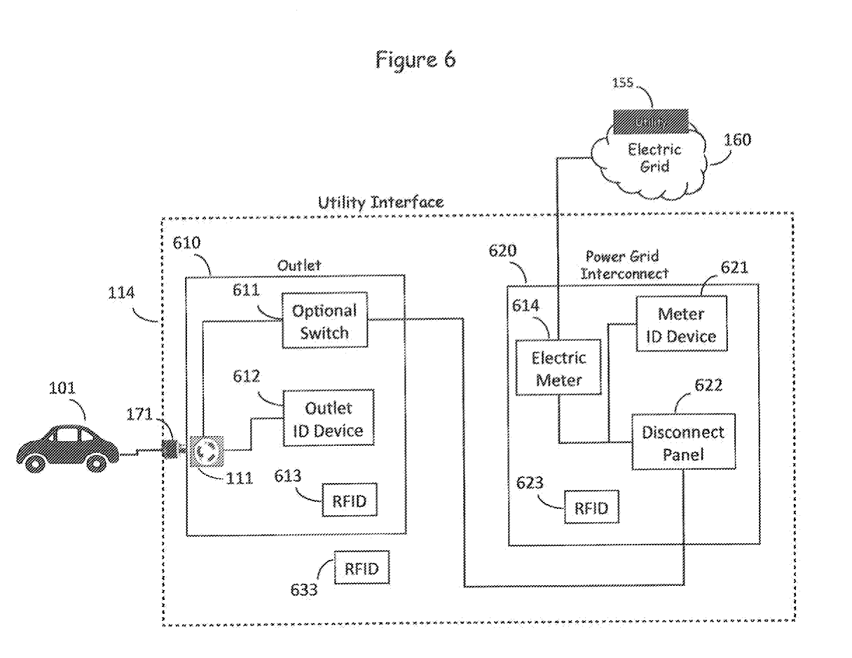

FIG. 6 illustrates an embodiment of the present Self-Identifying Power Source for use in the E-Grid system. The Self-Identifying Power Source 116 can be implemented in a variety of ways, and FIG. 6 illustrates the components that can be used to produce and transmit a unique identification of the power source to a Vehicle for energy consumption credit and billing purposes. As noted above, it is a problem in the field of recharging systems for vehicles equipped with electrically powered propulsion systems to bill the vehicle operator or the financially responsible party for the energy consumption where the electric grid is used as the source of power to charge the vehicular battery banks. Presently, each outlet (or jack or inductive power source) that is served by a local utility company is connected to the electric grid by a utility meter which measures the energy consumption of the loads that are connected to the outlet. The utility company bills the owner of the premises at which the outlet is installed for the total energy consumption for a predetermined time interval, typically monthly.

The solution to this problem is to have the vehicle self-meter its energy consumption in recharging the vehicular battery banks and report the energy consumption to the utility company that serves the power source to which the vehicle is connected. The utility company can then bill the vehicle owner and simultaneously credit the power source for this consumption. In implementing this paradigm, the power source identification can be implemented at various layers of the power distribution network. The outlet 111 to which the Vehicle 101 connects can identify itself, the utility interface 114 (such as a utility meter) can identify itself, or the premises at which the outlet 111 and the utility interface 114 (in this example, a meter 614) are installed and physically located can be identified. All of these scenarios are effective to enable the utility company to credit the owner of the power source with the power consumed by Vehicle 101.

### Power Source Identification—Outlet Level

A first implementation of the power source identification is at the outlet level, where the self-identifying element comprises an electrical outlet 111 having a housing into which are molded a plurality of conductors that function to conduct the electricity from the electric meter 614 (and associated circuit protection devices) to a plug 171 from the Vehicle 101 which is inserted into the outlet 111 of the Self-Identifying Power Source 1 16. There are numerous outlet conductor configurations which are specified by regulatory agencies, such as the National Electric Manufacturers Association (NEMA), for various voltages and current capacities; and a typical implementation could be a 2-pole 3-wire grounding outlet to reduce the possibility that the plug which is connected to the vehicle would be inadvertently disconnected from the Self-Identifying Power Source 116.

The Self-Identifying Outlet 610 of the Self-Identifying Power Source 116 includes an outlet identification device 612 which transmits outlet identification data to the Vehicle 101. This outlet identification data represents a unique code which identifies this particular Self-Identifying Outlet 610 of the Self-Identifying Power Source 116 in order for the owner of the associated electric meter 614 to receive credit for the energy consumption associated with the present vehicle battery recharging process. This outlet identification data can be transmitted over the power conductors or can be wirelessly transmitted to the vehicle by the outlet identification device 612, or may constitute an RFID solution where the vehicle reads the RFID code embedded in RFID device 613 located in the Self-Identifying Outlet 610 of the Self-Identifying Power Source 116. In addition to the unique identification of the Self-Identifying Outlet 610 of the Self-Identifying Power Source 116, the data can indicate the mode of data transmission appropriate for this locale. Thus, the vehicle may be instructed via this locale data to wirelessly transmit the accumulated energy consumption data to a local premises server for accumulation and forwarding to the utility company, or wirelessly via a public communication network 150 directly to the utility company, or via the power conductors 163 to a communications module associated with the electric meter 614, or to the utility company 155 via the Electric Grid 160.

In operation, every time a mating plug is inserted into the outlet 111 of the Self-Identifying Power Source 116 or the Vehicle 101 “pings” the Self-Identifying Outlet 610, the outlet identification device 612 outputs the unique outlet identification data or RFID Device 613 provides a passive identification read capability to enable the Vehicle 101 to uniquely identify the Self-Identifying Outlet 610 of the Self-Identifying Power Source 116.

In addition, a power switch 611 can optionally be provided to enable the utility 155 to disable the provision of power to Vehicle 101 pursuant to the authorization process described below. Switch 611 can be activated via a power line communications session with the utility company 155 via the electric grid 160. Alternatively, this switch could be “virtual” and located in the vehicle itself where the vehicle does not permit charging to occur even though the outlet 111 may be “hot” or have power to it.

### Power Source Identification—Electric Grid Interconnect Level

A second implementation of the power source identification is at the level of the electric grid interconnect 620, where the self-identifying element comprises one or more identification devices associated with the electric meter 614. Since each premises is equipped with an electric meter 614 required by the utility company and one or more disconnect devices 622 to serve one or more outlets 610, the identification of a utility meter as the electric grid interconnect is sufficient data to enable the utility company to credit the premises owner with the power consumed by the Vehicle 101. Since the Vehicle 101 self-meters, it is irrelevant which outlet 111 serves to provide power to the Vehicle 101. The energy consumption session, as described in more detail below, is not dependent on the exact physical connection of Vehicle 101 to an outlet 111 but can be managed at the power grid interconnection 620 level.

Thus, meter identification device 621 transmits meter identification data to the Vehicle 101. This meter identification data represents a unique code which identifies this particular electric meter 614 of the Self-Identifying Power Source 116 in order for the owner of the associated electric meter 614 to receive credit for the energy consumption associated with the present vehicle battery recharging process. This meter identification data can be transmitted over the power conductors or can be wirelessly transmitted to the vehicle by the meter identification device 621, or may constitute an RFID solution where the vehicle reads the RFID code embedded in RFID device 623 located in the power grid interconnect 620 of the Self-Identifying Power Source 116. In addition to the unique identification of the power grid interconnect 620 of the Self-Identifying Power Source 116, the data can indicate the mode of data transmission appropriate for this locale. Thus, the vehicle may be instructed via this locale data to wirelessly transmit the accumulated energy consumption data to a local premises server for accumulation and forwarding to the utility company, or wirelessly via a public communication network 150 directly to the utility company, or via the power conductors 163 to a communications module associated with the electric meter 614, or to the utility company 155 via the Electric Grid 160.

### Power Source Identification—Premises Level

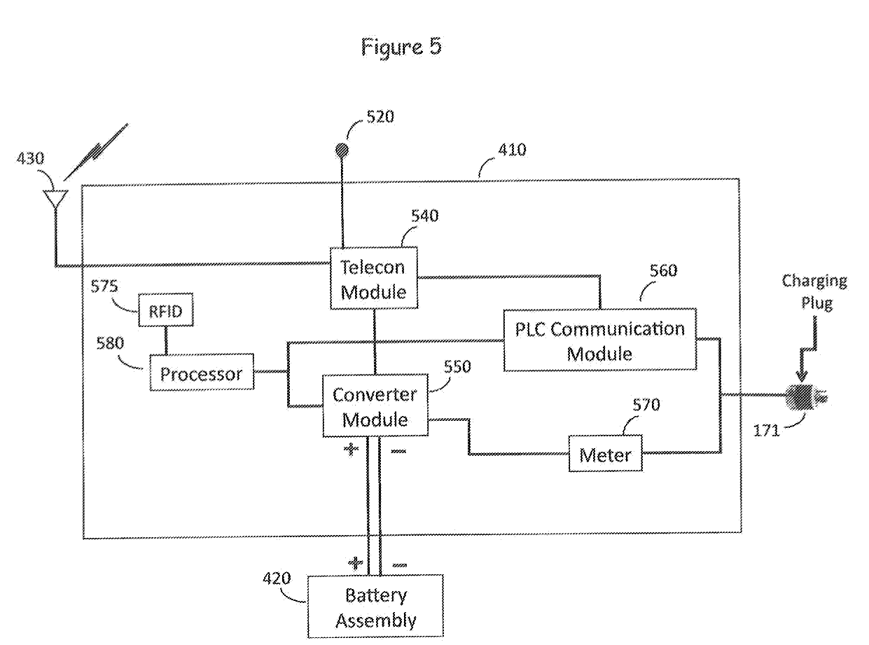

The recharging process to include billing and crediting is not necessarily dependent on meter 614 shown in FIG. 6. For example, a third embodiment involves an intelligent identification communication architecture communicated via Power Line Carrier (PLC) communication from Utility 155 to Electric Grid 160 which ultimately arrives at each and every outlet in the universe of the Electric Grid 160. This intelligent Outlet ID is communicated directly to outlet 111 (not shown directly on FIG. 6) wherein each outlet has a unique ID as identified and managed by the Utility 155. This PLC ID communication goes directly from Utility 155 to Electric Grid 160 via Utility Interface 114 to Vehicle 101 to PLC Communication Module 560 (shown in FIG. 5).

A fourth implementation of the power source identification is at the premises level, where the self-identifying element comprises one or more identification devices (such as RFID device 633) associated with the physical premises served by one or more power grid interconnects 620. Since a plurality of electric meters 614 can be used to serve a plurality of outlets 111 located at a physical premises, the granularity of identifying the owner of the premises is sufficient to implement the energy consumption credit process as described herein. Thus, the Vehicle 101 can sense an RFID device 633 upon entry into the premises at which the outlet 111 is located and use the RFID data, as described above, as the utility company customer identification, since the Vehicle 101 self-meters its energy consumption.

### Vehicle Infrastructure

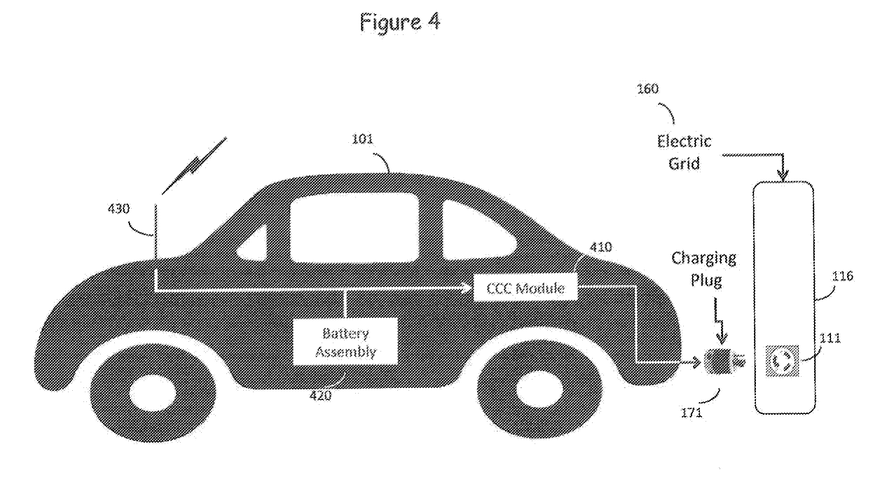

FIG. 4 illustrates, in block diagram form, the Charging, Control, and Communicator (CCC) module 410 installed in a vehicle; and FIG. 5 illustrates, in block diagram form, a detailed block diagram of the CCC module 410. The Vehicle 101 is equipped with an electrically powered propulsion system and vehicular battery banks 420 (or any such device that can store electrical energy). Presently, each outlet that is served by a local utility company is connected to the electric grid 160 by a utility meter 614 housed in Utility Interface 114 which measures the energy consumption of the loads that are connected to the outlet. The utility company bills the owner of the premises at which the outlet is installed for the total energy consumption for a predetermined time interval, typically monthly. Recharging a vehicle which is equipped with an electrically powered propulsion system results in the premises owner being billed for the recharging and the vehicle owner not being billed.

The present paradigm is to place the “electric meter” in the vehicle itself to eliminate the need to modify the electric grid. As shown in FIG. 6, the present Self-Identifying Power Source 116 provides the vehicle's electric meter with a unique identification of the outlet 111 to enable the vehicle to report both the vehicle's energy consumption and the point at which the energy consumption occurred to the utility company via the ubiquitous communications network. The consumption can be reported for each instance of connection to the electric grid or the Vehicle can “accumulate” the measure of each energy consumption session, then periodically transmit energy consumption information along with the associated unique outlet identification data to the power company or a third party billing agency via the communication network. Alternatively, transmission of these signals to the power company via power lines is a possibility (Power Line Carrier). Another mode of billing is for the vehicle to be equipped with a usage credit accumulator which is debited as power is consumed to charge the vehicle's battery. The credit accumulator is replenished as needed at predetermined sites or via WiFi/Cellular or via Power Line Carrier.

The Charging, Control, and Communicator (CCC) module 410 is shown in additional detail in FIG. 5. The Vehicle 101 is equipped with either an inductive coupler (not shown) or a plug 171 to enable receipt of electric power from the Self-Identifying Power Source 116. Plug 171 is constructed to have the proper number and configuration of conductors to mate with Self-Identifying Power Source 116 in well-known fashion. These conductors are connected to meter 570 which measures the energy consumption of the circuitry contained in Charging, Control, and Communicator module 410. The principal load is converter module 550 which converts the electric voltage which appears on the conductors of plug 171 into current which is applied to battery assembly 420 thereby to charge battery assembly 420 in well-known fashion. The Processor 580 could call for a quick charge at a higher amperage, provided the Utility permits it; or the Processor 580 could call for a “trickle charge” over a number of hours. Processor 580 regulates the operation of charging module to controllably enable the charging of the battery assembly 420 (or such device that can store electrical energy) and to provide communications with the Utility Service Center 100. In particular, the processor 580 receives the unique identification data from Self-Identifying Power Source 116 once the plug 171 is engaged in Self-Identifying Power Source 116, or via wireless means such as using RFID without an actual physical connection as previously discussed, and then initiates a communication session with Utility Service Center 100 to execute the AAA process as described herein. The communications with the Utility Service Center 100 can be in the wireless mode via antenna 530, or a wired connection 520, or via the conductors of the plug 171. An RFID reader 575 is provided to scan RFID devices associated with the outlet/electric meter/premises to which Vehicle 101 is sited to recharge battery assembly 420 as described herein. Finally, the ID communication can also be via PLC across the grid from the Utility wherein the Utility has, through its vast PLC network overlaid on its electric grid, created a unique ID for each Outlet, where a given ID is communicated from plug 171 to PLC Communication Module 560. Given the grid is also a communication network with intelligence means any given outlet can have its ID dynamically modified per operational requirements of the Utility.

In addition, processor 580 is responsive to data transmitted from the Utility Service Center 100 to either activate or disable the converter module 550 as a function of the results of the AAA process. Once the charging process is completed, the processor 580 reads the data created by meter 570 and initiates a communication session via communications module 540 with the Utility Service Center 100 to report the identity of Vehicle 101, the energy consumption in the present recharging session, and the associated unique identification of Self-Identifying Power Source 116 thereby to enable the utility company to credit the owner of Self-Identifying Power Source 116 and also bill the vehicle owner.

### Load Management Process

The Utility can effect load management by permitting the current flowing through plug 171 as controlled by processor 580 which is in communication with Utility Service Center 100 to be at a specified level, or it can be terminated for given periods of time when peak load conditions are occurring on the grid, say due to a heat wave where air conditioners are all on maximum. More details on Load Management follow below.

### Energy Consumption Billing Process

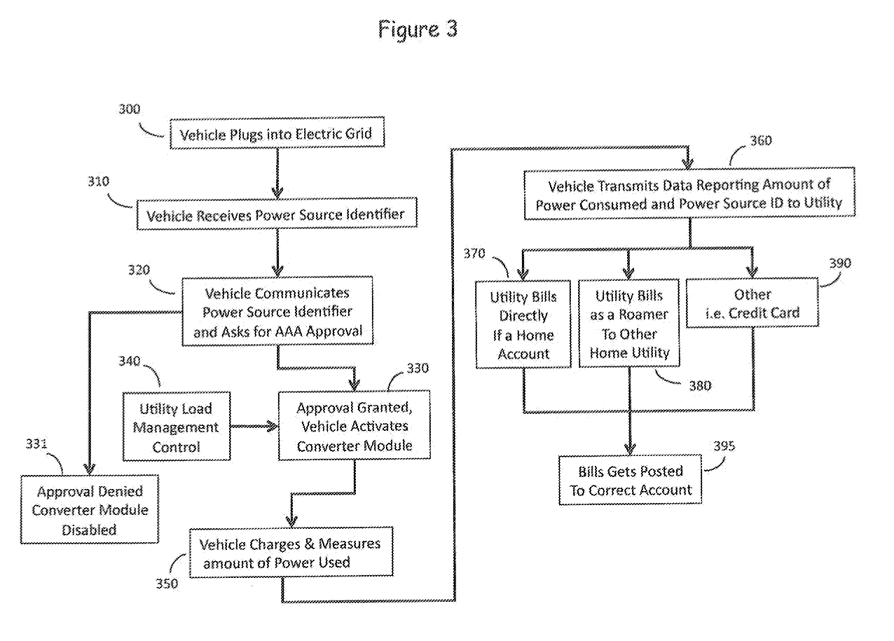

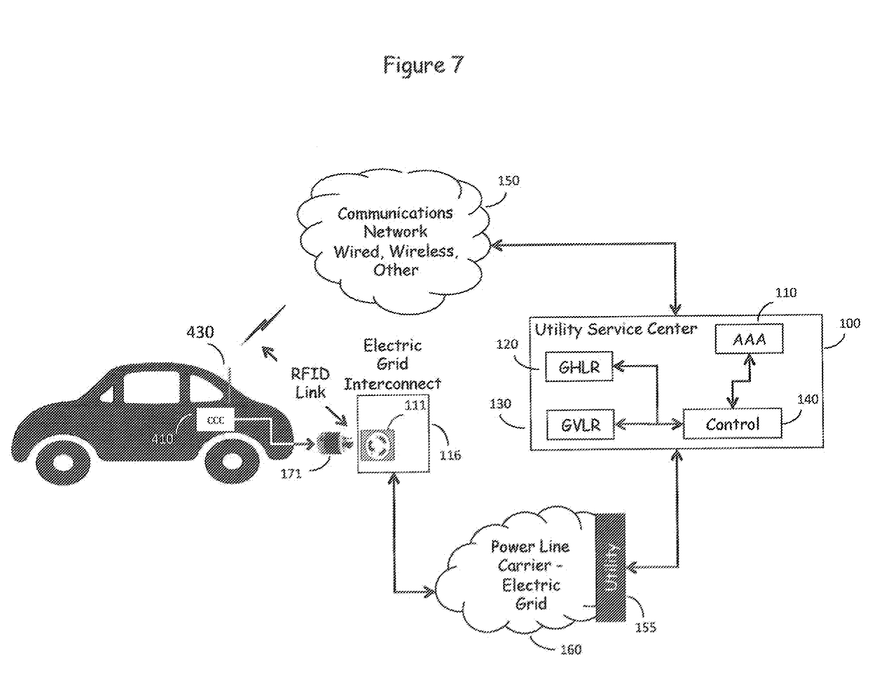

FIG. 3 illustrates, in flow diagram form, the operation of the billing system for the E-Grid system; and FIG. 7 illustrates, in block diagram form, the communications interconnections in use in the E-Grid network. For example, Vehicle 101 at step 300 plugs into outlet 111 of Self-Identifying Power Source 116 and at step 310 receives the Self-Identifying Power Source 116 identification information as described above, such as via an RFID link. At step 320, processor 580 accesses Communication Network 150 (or Power Line Carrier and Electric Grid 160) to communicate with Utility Service Center 100 and register on Grid Home Location Register 120 (or Grid Visitor Location Register 130). Vehicle 101 either is denied service at step 331 by Utility Service Center 100 due to a lack of credit, or lack of verification of identity, or gets authorization at step 330 from AAA System 110 to recharge the vehicle batteries 420. As a part of the communication process, processor 580 communicates all of the “Utility Centric” data it derived when it plugged into the Self-Identifying Power Source 116 as described above (utility name, location of charging outlet, and so on). As one means for managing possible charging fraud, the location of the charging jack could be cross-correlated with a GPS location (where a GPS module could be inserted into device 410 (not shown for clarity). Now, the AAA System 110 knows who to bill, who to pay, and so on.

An electrical power meter 570 inside the Vehicle 101 measures the amount of energy being consumed at step 350. When the plug 171 is pulled at step 360, and charging is complete, the meter in Vehicle 101 initiates a communication session via communication module 540 with the Utility Service Center 100 to report the identity of Vehicle 101, the energy consumption in the present recharging session, and the associated unique identification of Self-Identifying Power Source 116 thereby to enable the utility company to credit the owner of Self-Identifying Power Source 116 and also bill the vehicle owner. In addition, the vehicle owner is charged for the energy consumption via their home account at step 370, or via a roamer agreement at step 380, or via a credit card at step 390. At this point, if there were a property owner revenue share, this would also be recorded as a credit to that given property owner, and all billing is posted to the proper accounts at step 395.

### Load Management

The Utility Service Center 100 is the origination point for a Load Management situation, in which Vehicles 101 and 102 (or Vehicles 291-295) can be controlled to temporarily stop charging. There is a mapping algorithm that maps the geographic position of the charging device (via GPS) or via the Grid Identifier passed along by the Vehicle. The Utility knows that those two devices, for example, are in a region that is experiencing very heavy electrical demand. So, to help manage the demand, the Utility 155, via Communication Network 150 (or via PLC across Electric Grid 160 to Utility Interface 114) sends a command to Vehicles 101, 102 to temporarily stop charging (or until demand is lighter to re-initiate the charging sequence). In addition, the vehicles could be instructed to continue their charging sequence but charge at a lower level, or a given vehicle could ask for permission to charge at a very high rate to reduce the charge time.

This is an effective process since the amount of recharge is known, recharge can be scheduled based on grid capacity, and there is a recharge schedule. People are creatures of habit, so the vehicle would “know” how long you typically park: at work eight hours, at night until daybreak, etc. Thus, the vehicle, in conjunction with the Utility Service Center 100, can implement a precise time of day/usage pattern for charging.

### Using the Stored Energy in the Vehicle Batteries as a Peaking Source of Power for the Utility

As shown in FIG. 1, Vehicles 101, 102 are able to charge from the electric grid 160 via path 162, and are also able to “push” energy back to the electric grid 160 via path 163. Similarly, in FIG. 2, Vehicles 291-295 are able to charge from the electric grids 240, 250 via paths 271-275, and are able to “push” energy back to the electric grids 240, 250 via paths 271-275. This “pushing” of energy from the vehicles' energy storage systems, whether they are batteries or some other form of energy storage device, permits the utilities to manage peak loads on the network by using the collective energy of all of the vehicles then connected to the E-Grid as “peakers” and it would diminish the need for utilities to build “Peaking Power Plants”, which are very expensive to build and very expensive to operate, to handle the infrequent times when they need more energy to be supplied to the grid to prevent brownouts and blackouts.

### A Simplified Communications Block Diagram—FIG. 7

In order to remove some of the architecture complexity, and to clearly describe the core invention in a slightly different manner, a minimalist figure (FIG. 7) was created to show the key building blocks of the E-grid system communication architecture. While the invention is completely novel in its own right, there are two key architectural elements that enable the preferred embodiment described herein: (1) the placement of the meter measuring the power consumption during the charging sequence into the vehicle itself; and (2) the addition of the Utility Service Center 100 to manage Authentication, Authorization, and Accounting, where device 100 enables any electrical outlet to be available for charging and enables any utility to be a “member” of the “E-grid” system. Shown in FIG. 7, a bidirectional communication network is created between the CCC (Charging, Control, and Communicator) module 410 via Communications Network 150 and/or via Power Line Carrier via 160 to the Utility Service Center 100. Within the CCC module 410 is a meter 570 that measures the power consumed during a charging cycle, and it communicates the amount of energy consumed via 410 to 430 via 150 or 171 via 160 ultimately to 100. CCC module 410 also receives the Self Identifying Power Source 116 identification of the outlet 111 via a variety of means: RFID 613 and 575, Smart Meter 614, Smart ID Architecture via Power Line Carrier via Utility 155 across Electric Grid 160 to 111 connected to 171 to PLC Communication Module 560 in CCC module 410, and via a Self Identifying Outlet 610. The pairing of the unique Outlet ID with the energy consumed and measured by the vehicle and then collectively transmitted to the Utility Service Center 100 enables billing of the owner of the vehicle (or account holder for the vehicle), crediting of the owner of the physical plug (jack) where the power was taken from, and correct payment to the utility that supplied the energy. This architecture does not require new infrastructure to implement and can be operating in a matter of months versus years.

### SUMMARY

The present Self-Reporting Vehicle provides a unique identification of an outlet to a vehicle which is connected to the outlet to enable the vehicle to report the vehicle's power consumption to the utility company to enable the utility company to bill the vehicle owner and credit the outlet owner for the power consumed by the recharging of the vehicular battery banks.

What is claimed as new and desired to be protected by Letters Patent of the United States is:

1. A system for managing the electrical charging of a vehicle which includes a propulsion system powered, at least in part, by electric power, at least some of which is stored onboard the vehicle in an electric energy storage apparatus, comprising:
electric plug means connected to an electric energy storage apparatus for connecting to a source of electric power to provide electric power to said electric energy storage apparatus;
identification means, which receives power source identification data, which uniquely identifies said source of electric power from said source of electric power;
meter means, which generates power consumption data indicative of a flow of electric power from said source of electric power through said electric plug means to said electric energy storage apparatus; and
billing means which transmits said power consumption data and said associated power source identification data via a communication medium to a destination for billing purposes.

2. The system for managing the electrical charging of a vehicle which utilizes electric power of claim 1 wherein said electric plug means comprises:
continuity means that provides an indication when said electric energy storage apparatus is connected to said source of electric power.

3. The system for managing the electrical charging of a vehicle which utilizes electric power of claim 1, further comprising:
switch means to controllably enable a flow of power from said source of electric power to said connected electric energy storage apparatus.

4. The system for managing the electrical charging of a vehicle which utilizes electric power of claim 1 wherein said electric plug means comprises:
inductive coupling means, which uses a wireless mode of transfer of electric power from said source of electric power to said electric energy storage apparatus.

5. The system for managing the electrical charging of a vehicle which utilizes electric power of claim 1 wherein said identification means comprises:
data transmission mode identification means for receiving data from said source of electric power which identifies a data transmission mode supported by said source of electric power.

6. The system for managing the electrical charging of a vehicle which utilizes electric power of claim 1, further comprising:
continuity determination means, which terminates said flow of electric power from said source of electric power in response to an interruption of said connection of said electric plug means to said source of electric power.

7. The system for managing the electrical charging of a vehicle which utilizes electric power of claim 1, further comprising:
communication means which establishes a communication connection to said communication medium to transmit said power consumption data and said associated power source identification data via said communication medium to a destination for billing purposes.

8. The system for managing the electrical charging of a vehicle which utilizes electric power of claim 7 wherein said communication means comprises:
disconnect means for disabling said flow of electric power from said source of electric power through said electric plug means to said electric energy storage apparatus in response to load demand control signals received from said destination.

9. The system for managing the electrical charging of a vehicle which utilizes electric power of claim 7 wherein said communication means comprises:
power flow reversal means for enabling a flow of electric power from said electric energy storage apparatus through said electric plug means to said source of electric power in response to load demand control signals received from said destination.

10. The system for managing the electrical charging of a vehicle which utilizes electric power of claim 1 wherein said billing means comprises:
consumption accumulation means for storing a plurality of sets of said power consumption data and said associated power source identification data for transmission to a destination for billing purposes.

11. A method for managing the electrical charging of a vehicle which includes a propulsion system powered, at least in part, by electric power, at least some of which is stored onboard the vehicle in an electric energy storage apparatus, comprising:
providing, via an electric plug connected to an electric energy storage apparatus, a connection to a source of electric power to provide electric power to said electric energy storage apparatus;
receiving power source identification data, which uniquely identifies said source of electric power, from said source of electric power;
generating power consumption data indicative of a flow of electric power from said source of electric power through said electric plug to said electric energy storage apparatus; and
transmitting said power consumption data and said associated power source identification data via a communication medium to a destination for billing purposes.

12. The method for managing the electrical charging of a vehicle which utilizes electric power of claim 11 wherein said step of providing comprises:
providing an indication when said electric energy storage apparatus is connected to said source of electric power.

13. The method for managing the electrical charging of a vehicle which utilizes electric power of claim 11, further comprising:
controllably enabling a flow of power from said source of electric power to said connected electric energy storage apparatus.

14. The method for managing the electrical charging of a vehicle which utilizes electric power of claim 11 wherein said step of providing comprises:
using a wireless mode of transfer of electric power from said source of electric power to said electric energy storage apparatus.

15. The method for managing the electrical charging of a vehicle which utilizes electric power of claim 11 wherein said step of receiving comprises:
receiving data from said source of electric power which identifies a data transmission mode supported by said source of electric power.

16. The method for managing the electrical charging of a vehicle which utilizes electric power of claim 11, further comprising:
terminating said flow of electric power from said source of electric power in response to an interruption of said connection of said electric plug to said source of electric power.

17. The method for managing the electrical charging of a vehicle which utilizes electric power of claim 11, further comprising:
establishing a communication connection to said communication medium to transmit said power consumption data and said associated power source identification data via said communication medium to a destination for billing purposes.

18. The method for managing the electrical charging of a vehicle which utilizes electric power of claim 17 wherein said step of establishing comprises:
disabling said flow of electric power from said source of electric power through said electric plug to said electric energy storage apparatus in response to load demand control signals received from said destination.

19. The method for managing the electrical charging of a vehicle which utilizes electric power of claim 17 wherein said step of establishing comprises:
enabling a flow of electric power from said electric energy storage apparatus through said electric plug to said source of electric power in response to load demand control signals received from said destination.

20. The method for managing the electrical charging of a vehicle which utilizes electric power of claim 11 wherein said step of transmitting comprises:
storing a plurality of sets of said power consumption data and said associated power source identification data for transmission to a destination for billing purposes.
